(19) United States
(12) Patent Application Publication
(10) Pub. No.: US 2018/0374170 A1
(43) Pub. Date: Dec. 27, 2018

(54) SYSTEM AND METHOD TO RATE REAL ESTATE AGENTS

(71) Applicant: Carrier Corporation, Palm Beach Gardens, FL (US)

(72) Inventors: Adam Kuenzi, Silverton, OR (US); Jackson Beatty, Molalla, OR (US)

(73) Assignee: Carrier Corporation, Palm Beach Gardens, FL (US)

(21) Appl. No.: 16/017,358

(22) Filed: Jun. 25, 2018

Related U.S. Application Data
(60) Provisional application No. 62/525,428, filed on Jun. 27, 2017.

(51) Int. Cl. G06Q 50/16; G06F 17/30; G06Q 30/02

(52) U.S. Cl. CPC G06Q 50/16; G06Q 30/0282; G06F 17/30867

(57) ABSTRACT

A method for comparing real estate agents includes receiving data regarding a subject property from a handheld device operating a real estate agent review application; determining a set of buyers based on the subject property; filtering the set of buyers to obtain a identified set of buyers; determining at least one real estate agent for whom feedback was provided by at least one of the identified set of buyers; and communicating the at least one real estate agent to the handheld device operating the real estate agent review application.

### CROSS-REFERENCE TO RELATED APPLICATIONS

This application claims the benefit of provisional application Ser. No. 62/525,428, filed Jun. 27, 2017.

### BACKGROUND

The present disclosure relates generally to a rating system, and more particularly, to a system and method to rate real estate agents via a feedback application.

In the real estate industry, a home buyer typically does not have an existing relationship with a real estate agent. Real estate agents advertise themselves, but oftentimes, in real estate, word of mouth is the most effective method. However, buyers typically have relatively limited access to real estate agents from a relevant group of buyers.

### SUMMARY

A method for associating a prospective buyer with a compatible real estate agent, according to one disclosed non-limiting embodiment of the present disclosure can include electronically receiving buyer data from the prospective buyer; determining a set of comparable buyers based on the buyer data; identifying at least one real estate agent for whom feedback was provided by the at least one of the comparable buyers; and electronically communicating agent data for at least one of the identified agents to the prospective buyer.

A further embodiment of the present disclosure may include, wherein the determining the set of comparable buyers is based on a subject property.

A further embodiment of the present disclosure may include, wherein the determining the set of comparable buyers is based on at least one comparable property.

A further embodiment of the present disclosure may include, wherein the at least one comparable property relates to at least one of comparable geographical area, comparable price, comparable number of bedrooms, and comparable number of bathrooms.

A further embodiment of the present disclosure may include, wherein the buyer data includes a buyer interests.

A further embodiment of the present disclosure may include, wherein the buyer interests relates to an interest of the set of comparable buyers in the subject property.

A further embodiment of the present disclosure may include, wherein the buyer interests relates to an interest of the set of comparable buyers in at least one comparable property.

A further embodiment of the present disclosure may include, wherein the at least one comparable property relates to at least one of comparable geographical area, comparable price, comparable number of bedrooms, and comparable number of bathrooms.

A further embodiment of the present disclosure may include, wherein the buyer data includes a buyer characteristic.

A further embodiment of the present disclosure may include, wherein the buyer characteristics relates to at least one of whether the buyer is married/single, their ethnicity, their income level, and their age.

A further embodiment of the present disclosure may include, wherein the electronically communicating agent data for the at least one of the identified agents to the prospective buyer includes electronically communicating an agent feedback rating for the at least one of the identified agents.

A further embodiment of the present disclosure may include, wherein the agent feedback rating includes at least one of safety, flexibility, responsiveness, knowledge, and service provided.

A further embodiment of the present disclosure may include communicating with the at least one of the comparable buyers via a real estate agent review application regarding the at least one of the identified agents.

A system for associating a prospective buyer with a compatible real estate agent, according to one disclosed non-limiting embodiment of the present disclosure can include a buyer server; a buyer storage system in communication with the buyer server, the buyer storage system including a database that stores feedback from buyers; and a listing recommendation server hosting an analytics software application that determines a set of comparable buyers from the buyers stored in the buyer storage system based on buyer data from a prospective buyer, then identifies at least one real estate agent for whom feedback was provided by the at least one of the comparable buyers.

A further embodiment of the present disclosure may include a handheld device running a real estate agent review application, the real estate agent review application in electronic communication with the buyer server to receive data for the at least one real estate agent.

A further embodiment of the present disclosure may include, wherein the buyer data includes a buyer interests.

A further embodiment of the present disclosure may include, wherein the buyer interests relate to an interest of the set of comparable buyers in a subject property.

A further embodiment of the present disclosure may include, wherein the buyer interests relate to an interest of the set of comparable buyers in at least one comparable property comparable to a subject property.

A further embodiment of the present disclosure may include, wherein the buyer data includes a buyer characteristic.

A further embodiment of the present disclosure may include, wherein the buyer characteristics relates to at least one of whether the buyer is married/single, their ethnicity, their income level, and their age.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate application system.

FIG. 2 is a schematic diagram of a handheld device.

FIG. 3 is a flowchart of a method to provide communication for a real estate transaction with the system of FIG. 1.

FIG. 4 is a screenshot of the real estate application property listing view.

FIG. 5 is a schematic system diagram of a portion of the real estate application system.

FIG. 6 is a flowchart of a method to determine an agent using a real estate agent review application.

FIG. 7 is a screenshot of example filters for the real estate agent review application.

FIG. 8 is a screenshot of the real estate agent review application for display on a handheld device.

### DETAILED DESCRIPTION

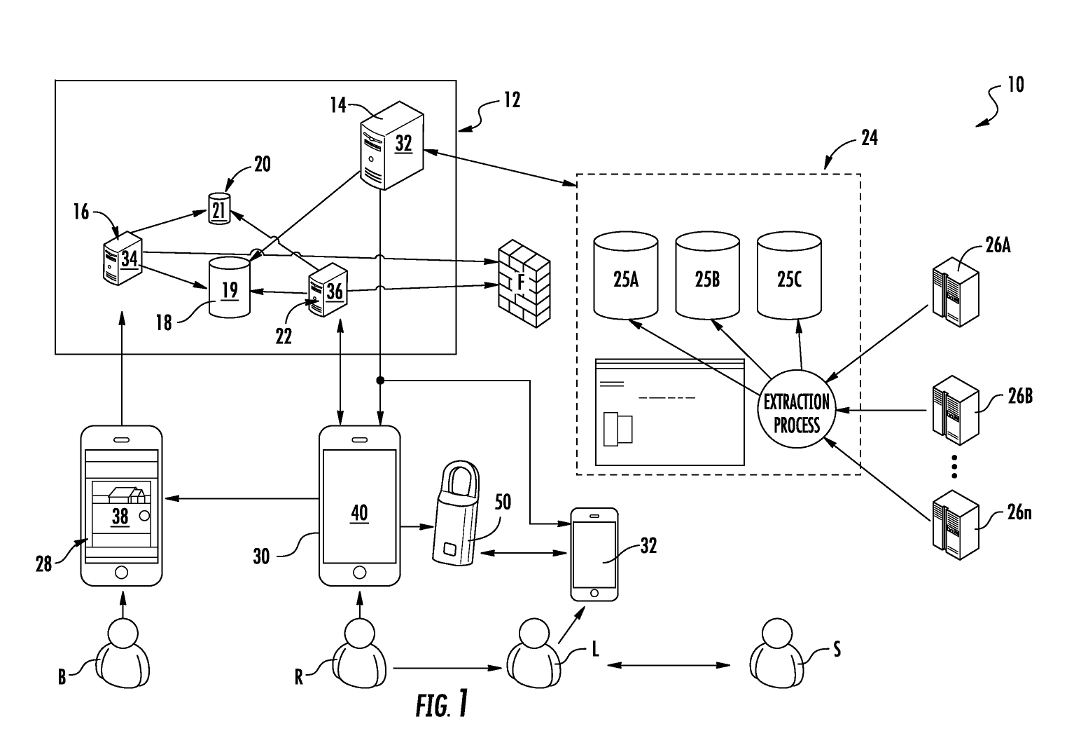

FIG. 1 schematically illustrates a system 10 to facilitate communication for real estate transactions. A property buyer “B” is typically represented by a showing agent “R” while a property seller “S” is typically represented by a listing agent “L.” The listing agent “L” communicates with the buyer “B” only indirectly, such as by communication with the showing agent “R” who then communicates information with the buyer “B.” Although only particular agents are referred to in the illustrated embodiments, the functions of such personnel may be otherwise assigned or rearranged. For example, the listing agent “L” may be a senior person in an agency who utilizes a seller's assistant. The showing agent “R” may similarly utilize a showing assistant. As is discussed below, the prospective buyer “B” may wish to obtain input from third parties such as family, friends, and/or others.

The system 10 generally includes a subsystem 12 that may be controlled by a single owner. The subsystem 12 generally includes a listing recommendation server 14, a buyer server 16, a buyer storage system 18, a log storage system 20, and an electronic key server 22. The listing recommendation server 14 communicates with the buyer storage system 18, the log storage system 20, and a storage system 24. The buyer storage system 18 includes a database 19 that stores, for example, feedback created by the buyer “B” (e.g., buyer feedback, third party feedback, etc.). The log storage system 20 includes a database 21 that collects activity data associated with the property showings.

The storage system 24 may include, but not be limited to, a database for managing key holders 25A, a security database 25B that hosts security protocols, and a listing database 25C that stores extracted property data from external databases 26A, 26B, 26N. The storage system 24 communicates with the external databases 26A-26N such as the Real Estate Transaction Standard (RETS) framework that stores Multiple Listing Service (MLS) data. Communication between the various servers may include internet protocols or the like. The MLS data may include information such as number of bedrooms, number of bathrooms, price of listing, etc. RETS is a framework that can be adopted by computer systems to receive data from the MLS servers, as well as those of other real estate systems provided they also have software installed designed to communicate using the RETS framework. The national association of realtors refers to RETS as a “common language.”

A multiple of handheld devices 28, 30, 32, may electronically communicate with the subsystem 12. For example, the handheld devices 28, 30, 32, may be a smartphone, tablet, or other mobile device of the respective individual. Handheld device 28 is used by the potential buyer “B,” handheld device 30 is used by the showing agent “R,” and handheld device 32 is used by the listing agent “L. Various other handheld devices such as those used by the third parties “T” may also be in electronic communication with the subsystem 12 either directly or through communication with the handheld devices 28, 30, 32, as an intermediary.

Information is accessible by the listing agent “L” through the subsystem 12 so that the listing agent “L” can, for example, generate reports for their seller “S,” send updates about a particular listing to showing agents “R”, or provide feedback from a buyer “B” to their seller “S.” The subsystem 12 may also obtain information from a Real Estate Transaction Standard (RETS) framework that stores MLS data. The subsystem 12 may also obtain information generated by an electronic key box 50 that occurs as a consequence of the showing, such as number of times shown, time spent at the subject property for each showing, return showings, etc. The subsystem 12 may also be used by the listing agents “L” to receive automatic notification (e.g., email notices) when a showing occurs at their listings. The subsystem 12 may also be used by the buyer “B” as a repository for information (e.g., details of each property the buyer has viewed, feedback on the properties, etc.). The seller “S” can also receive feedback from the buyer “B” either directly from the subsystem 12, or through electronic communications with the listing agent “L” who communicates with the subsystem 12.

The listing recommendation server 14 hosts, for example, at least an analytics software application 32 that compiles and runs analytics against buyer ratings from the buyer data storage 18 and MLS listing data from the storage system 24. The buyer server 16 hosts a buyer application program interface (API) 34, and the electronic key server 22 hosts an electronic key API 36. An application program interface (API) may include a set of routines, protocols, and/or tools for building software applications. The API specifies how software components should interact. APIs are used when programming graphical user interface (GUI) components. A server-side web API is a programmatic interface with one or more publicly exposed endpoints to a defined request-response message system.

The listing recommendation server 14 may electronically communicate with a real estate application 38 on the handheld device 28 through the buyer API 34. An agent application 40 on the handheld device 30 may communicate with the listing recommendation server 14 and the electronic key server 22. The buyer API 34 and the electronic key API 36 may also communicate with other external systems through a firewall “F.”

The real estate application 38 may be a mobile application on the handheld device 28 that may be used by the buyer “B” to rate the properties they have seen and, as will be further described below, receive third party feedback from third parties “T” based on the buyer “B” feedback. The real estate application 38 communicates with the buyer storage system 18 through the buyer API 34 which then stores the feedback, ratings, and notes taken by the property buyer in the database 19 of the buyer storage system 18.

The agent application 40 may be a mobile application on the handheld device 30 that may be used by the showing agent “R” to access the electronic key boxes 50 via a short distance communication standard (e.g., Bluetooth). Alternatively, or in addition, the electronic key boxes 50 may be connected (e.g., cellular) directly to the listing recommendation server 14. The electronic key API 36 of the electronic key server 22 communicates with the agent application 40 to sync activity information from the electronic key boxes 50 to the electronic key API 36 (e.g., accessed key boxes, update the count of proprietary keys generated for that particular property, create a timestamp indicating that lockbox is opened), and showing notifications (e.g., to an associated showing agent “R”).

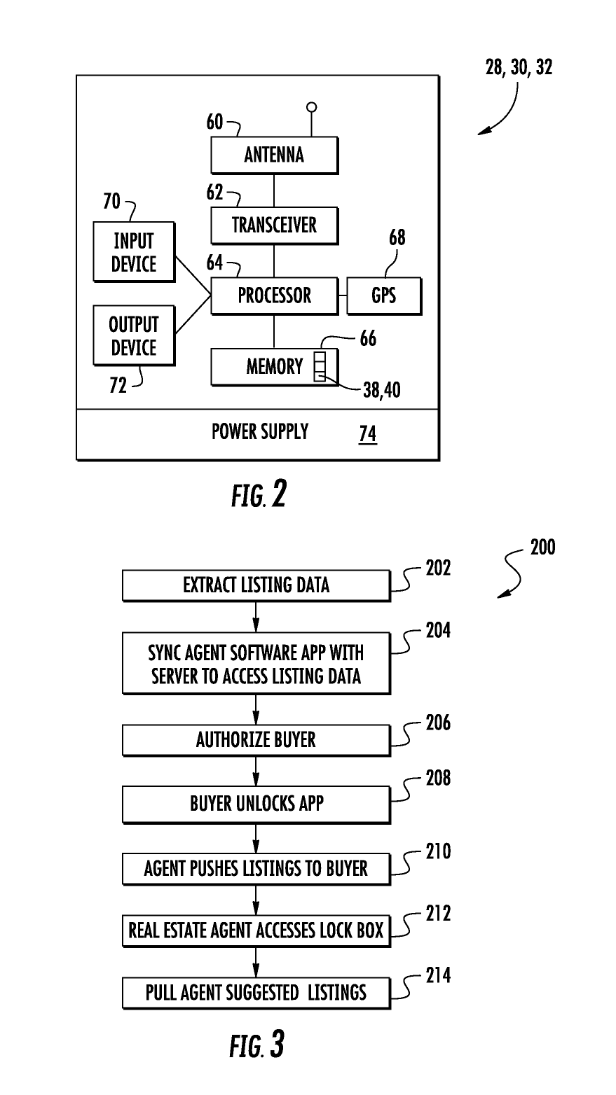

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc.

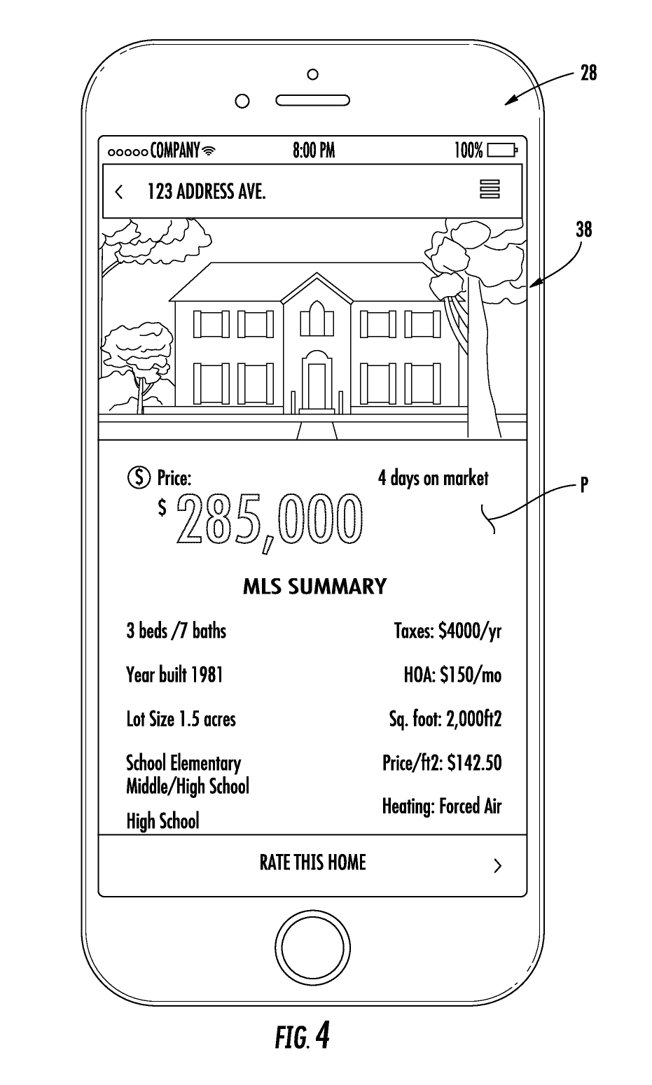

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) data such as MLS data from the external data servers 26A-26N (FIG. 1) through the listing recommendation server 14. Next, the agent application 40 syncs (204) with the listing recommendation server 14 and pulls MLS data for desired property listings of interest to the buyer “B” as, for example, selected by the showing agent “R.” This may be performed through an automated sync through the agent application 40. The showing agent “R” may also perform a manual sync to obtain the MLS data.

Through the agent application 40, the showing agent “R” can then authorize (206) the property buyer “B” to access the desired property listings of interest to the buyer “B.” Through the agent application 40, the showing agent “R” may, for example, authorizes the buyer “B” through input of buyer identification information (e.g., buyer name and email address.) The buyer identification information is then electronically communicated to the listing recommendation server 14 so that the listing recommendation server 14 communicates the buyer “B” (e.g., via email, text, or other electronic communication to provide a link to an app store) with a code to unlock (208) the real estate application 38. The buyer “B” is then authorized to download the real estate application 38 and the desired property listings of interest to the buyer “B,” to maintain the value of the showing agent “R” in the real estate transaction. Alterntively, the buyer “B” already has the real estate application 38 and the desired property listings of interest to the buyer “B” are readily received.

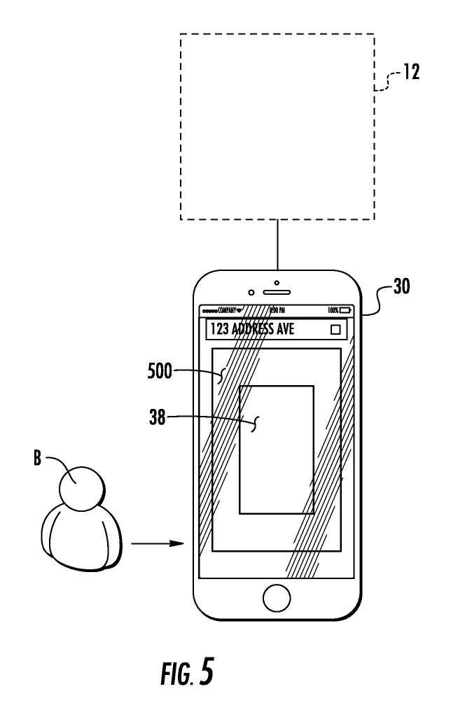

Through the agent application 40, the showing agent “R” can continue to push (210) property listings to the real estate application 38. Access may be provided for one or more properties by a showing code, or other information that unlocks one or more modules in the real estate application 38. The modules may include features or other aspects such as the real estate agent review application 500 (FIG. 5) that are particular tailored to certain parties in the real estate transaction. The showing agent “R” is able to selectively push the desired property listings of interest to the buyer “B” (one example property listing illustrated by screenshot “P”; FIG. 4) through the subsystem 12 to be viewable within the real estate application 38. The showing agent “R” also uses the agent application 40 to operate the electronic key box 50 to access the property for showing to the buyer “B.”

With reference to FIG. 5, in addition to the features discussed above, the buyer “B” can utilize a real estate agent review application 500 on their handheld device 30 to review their agent. The real estate agent review application 500 may be a separate application and/or a module of the real estate application 38.

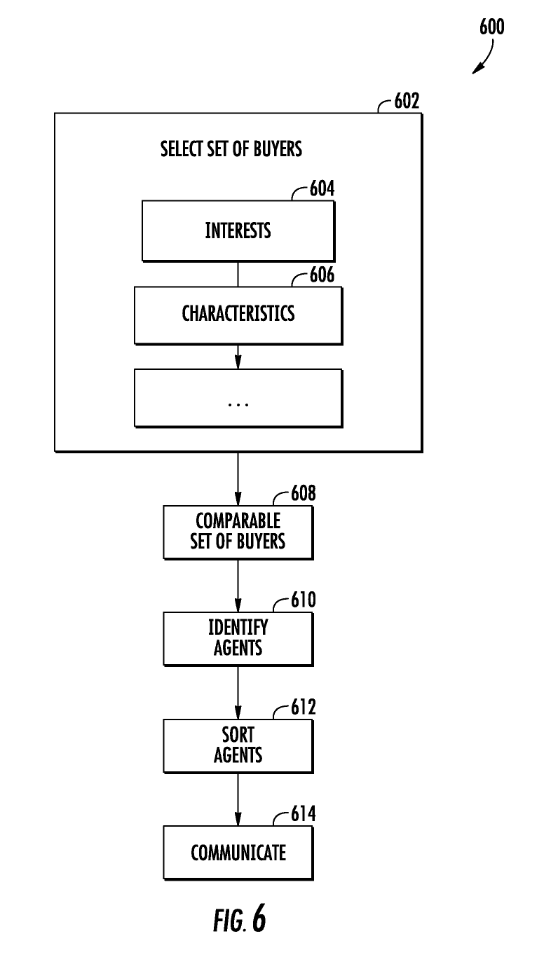

With reference to FIG. 6, a method 600 for associating a prospective buyer with a compatible real estate agent, for example based upon ratings from comparable buyers who have considered comparable properties and rated their agents, is illustrated in terms of functional block diagrams.

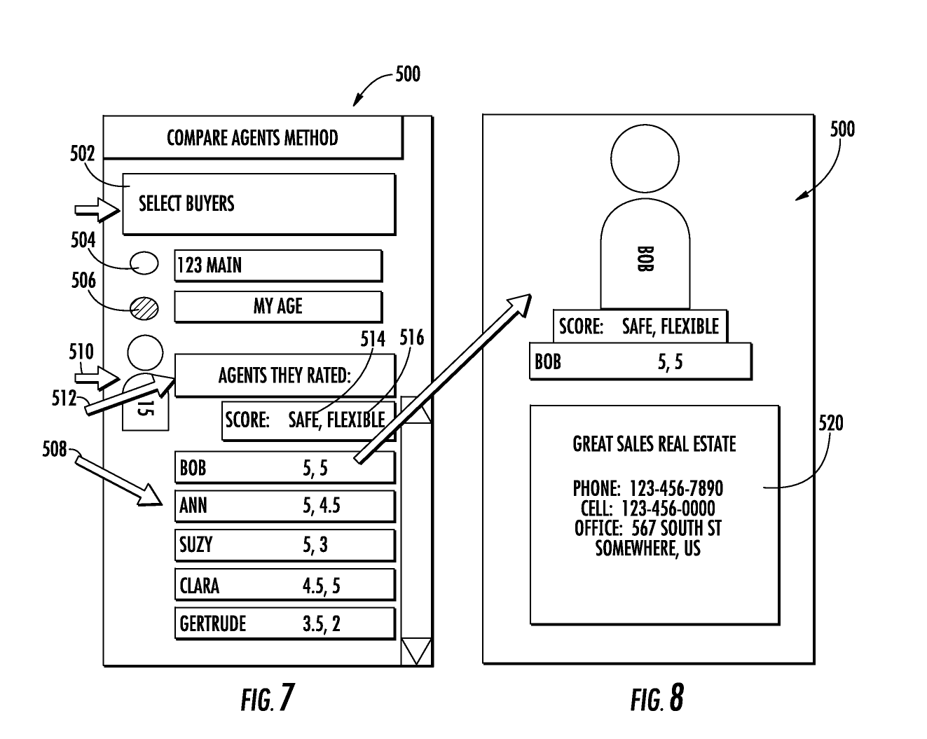

Initially, the prospective buyer accesses the real estate agent review application 500 on their handheld device 30 to select (602) buyers (FIG. 7; 502) via input of buyer data. The buyers are accessed by the real estate agent review application 500 through electronic communication with the listing recommendation server 14. The listing recommendation server 14 communicates with the buyer database system 18 through the buyer API 34 to identify buyers who have provided feedback on their real estate agent. The feedback may be stored in the database 19 of the buyer storage system 18 and/or in additional or alternative storage systems.

The buyer data is utilized by the real estate agent review application 500 to identify a comparable set of buyers. In at least one embodiment, the buyer data may be input into the real estate agent review application 500 by the prospective buyer “B” as buyer interests (604). Buyer interests may include, for example, the buyers stored in the database 19 who have shown an interest in the subject property. The buyer interests may also include buyers stored in the database 19 who have shown an interest in comparable properties.

In at least one embodiment, the prospective buyer can input an address (FIG. 7; 504) of the subject property to filter on the buyers stored in the database 19 who have visited the subject property. Alternatively, or in addition, buyers who have visited properties comparable to the subject property are identified. The real estate agent review application 500 may utilize MLS information from the subject property to obtain the comparable properties (e.g., the comparable properties that have comparable square footage, comparable price, comparable status, comparable bedrooms, comparable bathrooms, comparable garage, comparable fireplaces, comparable basement, etc. to the subject property). The real estate agent review application 500 then pulls the comparable properties from the buyers stored in the database 19 and associated buyers who have visited the comparable properties.

Alternatively, or in addition, the buyer data may be input into the real estate agent review application 500 by the prospective buyer “B” as buyer characteristics (606) (FIG. 7; 506). The buyer characteristics may be used to identify comparable buyers who are similar to the prospective buyer based on the buyer characteristics (606). For example, the buyer characteristics may include, but not be limited to, whether the buyers are married/single, their ethnicity, their income level, their age, etc. Filtering by buyer interests (604) and/or buyer characteristics (606) may be supplemented or replaced by other filtering. That is, the prospective buyer may select one or more additional or alternative filters through the buyer data.

In response to the selecting (602), an identified set of comparable buyers are determined (608) by the real estate agent review application 500. Alternatively, the comparable buyers may be determined by the subsystem 12. The comparable buyers (608) are then utilized to identify (610) at least one real estate agent for whom feedback was provided. The rated agents are then displayed 510 on the real estate agent review application 500. The at least one real estate agent for whom feedback was provided may be displayed as a number 510 (FIG. 7) to provide perspective to the prospective buyer as to the number of agents who may be compatible with the prospective buyer. This also provides an effective manner for further down selecting the number of compatible real estate agents. For example, if 100 agents are displayed, the prospective buyer may wish to further define the buyer data to reduce the number of agents to a more manageable number. The compatible real estate agents are then presented 508 (FIG. 7) on the real estate agent review application 500.

Next, the real estate agents may then be sorted (612) by the prospective buyer on the real estate agent review application 500. For example, the prospective buyer may sort the list of agents by selecting particular feedback characteristic ratings. The predetermined characteristic ratings of the agent may be those associated with previously uploaded feedback to the buyer database system 18 in responses to questionnaires or other feedback provided by the buyer regarding their agent. The agent's feedback characteristic ratings, (e.g., safety 514 (FIG. 7), flexibility 516 (FIG. 7), responsiveness, knowledge, service provided, etc.) may be ordered by the prospective buyer to sort the presented agent list. The compatible real estate agents are then listed in the rank order based on the agent's scores on the selected characteristics so that the prospective buyer can simply scroll through the list and select a desired compatible real estate agent to obtain the contact information 520, etc., for that real estate agent review application. (FIG. 8).

In addition, the real estate agent review application 500, through the listing recommendation server 14 and the buyer database system 18, may communicate (614) directly with the buyers who provided feedback (e.g., via email, text, or pop-up windows in an app that permit specific questions as to their satisfaction with their real estate agent). The real estate agent review application 500 allows a buyer who is looking for a home determine what real estate agent is trustworthy and can ask questions of other buyers to obtain word of mouth feedback without even personally knowing the buyers.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A method for associating a prospective buyer with a compatible real estate agent, comprising:
electronically receiving buyer data from the prospective buyer;
determining a set of comparable buyers based on the buyer data;
identifying at least one real estate agent for whom feedback was provided by the at least one of the comparable buyers; and
electronically communicating agent data for at least one of the identified agents to the prospective buyer.

2. The method as recited in claim 1, wherein determining the set of comparable buyers is based on a subject property.

3. The method as recited in claim 1, wherein determining the set of comparable buyers is based on at least one comparable property.

4. The method as recited in claim 3, wherein the at least one comparable property relates to at least one of comparable geographical area, comparable price, comparable number of bedrooms, and comparable number of bathrooms.

5. The method as recited in claim 1, wherein the buyer data includes a buyer interests.

6. The method as recited in claim 5, wherein the buyer interests relates to an interest of the set of comparable buyers in the subject property.

7. The method as recited in claim 5, wherein the buyer interests relates to an interest of the set of comparable buyers in at least one comparable property.

8. The method as recited in claim 7, wherein the at least one comparable property relates to at least one of comparable geographical area, comparable price, comparable number of bedrooms, and comparable number of bathrooms.

9. The method as recited in claim 1, wherein the buyer data includes a buyer characteristic.

10. The method as recited in claim 9, wherein the buyer characteristics relates to at least one of whether the buyer is married/single, their ethnicity, their income level, and their age.

11. The method as recited in claim 1, wherein the electronically communicating agent data for the at least one of the identified agents to the prospective buyer includes electronically communicating an agent feedback rating for the at least one of the identified agents.

12. The method as recited in claim 11, wherein the agent feedback rating includes at least one of safety, flexibility, responsiveness, knowledge, and service provided.

13. The method as recited in claim 11, further comprising communicating with the at least one of the comparable buyers via a real estate agent review application regarding the at least one of the identified agents

14. A system for associating a prospective buyer with a compatible real estate agent, comprising:
a buyer server;
a buyer storage system in communication with the buyer server, the buyer storage system including a database that stores feedback from buyers; and
a listing recommendation server hosting an analytics software application that determines a set of comparable buyers from the buyers stored in the buyer storage system based on buyer data from a prospective buyer, then identifies at least one real estate agent for whom feedback was provided by the at least one of the comparable buyers.

15. The system as recited in claim 14, further comprising a handheld device running a real estate agent review application, the real estate agent review application in electronic communication with the buyer server to receive data for the at least one real estate agent.

16. The system as recited in claim 14, wherein the buyer data includes a buyer interests.

17. The system as recited in claim 16, wherein the buyer interests relate to an interest of the set of comparable buyers in a subject property.

18. The system as recited in claim 16, wherein the buyer interests relate to an interest of the set of comparable buyers in at least one comparable property comparable to a subject property.

19. The system as recited in claim 14, wherein the buyer data includes a buyer characteristic.

20. The system as recited in claim 19, wherein the buyer characteristics relates to at least one of whether the buyer is married/single, their ethnicity, their income level, and their age.
